(19) United States
(12) Patent Application Publication
(10) Pub. No.: US 2017/0361329 A1
(43) Pub. Date: Dec. 21, 2017

(54) INFECTIOUS WASTE DISPOSAL

(71) Applicant: AEMERGE LLC, Fortville, IN (US)

(72) Inventors: Scott Behrens, Fortville, IN (US); Landon C.G. Miller, Fortville, IN (US)

(21) Appl. No.: 15/523,975

(22) PCT Filed: Jan. 12, 2016
(86) PCT No.: PCT/US2016/013067

§ 371 Date: May 3, 2017

Related U.S. Application Data
(60) Provisional application No. 62/102,258, filed on Jan. 12, 2015.

(51) Int. Cl. B02C 19/00; B02C 18/22; F23G 5/033; F23G 5/44; B09B 3/00

(52) U.S. Cl. CPC B02C 19/0075; F23G 5/448; B09B 3/0075; B09B 3/0083; F23G 5/033; B02C 18/2241; F23G 2201/80; F23G 2205/122; F23G 2205/18; F23G 2209/20

(57) ABSTRACT

A system for treating infectious waste is provided that employs a medical waste handling and shredding sub-system that feeds partially processed waste to an oxidizer to eliminate potential airborne infectious waste prior to transforming the medical waste into useful co-products. Medical waste is transformed into value added products including hydrocarbon based gases, hydrocarbon-based liquids, carbonized material, and recovered precious metals and rare earth materials in a system having as its transformative element an anerobic, negative pressure, or carbonization system. With medical waste as a feedstock for the production of valuable products, an economically viable and environmentally more responsible alternative to traditional methods of medical waste treatment is realized.

### CROSS REFERENCE TO RELATED APPLICATIONS

This application claims priority benefit of U.S. Provisional Application Ser. No. 62/102,258 filed 12 Jan. 2015; the contents of which are hereby incorporated by reference.

### FIELD OF THE INVENTION

The present invention in general relates to a system for treating infectious waste; and in particular to a medical waste handling and shredding sub-system with a built-in oxidizer to eliminate potential airborne infectious waste prior to transforming the medical waste into useful co-products, including hydrocarbon based gases, hydrocarbon-based liquids, precious metals, rare earths, and carbonized material in a system having as its transformative element an anerobic, negative pressure, or carbonization system.

### BACKGROUND OF THE INVENTION

Infectious medical waste is generated in the research, diagnosis, treatment, or immunization of human beings or animals and has been, or is likely to have been contaminated by organisms capable of causing disease. Infectious medical waste includes items such as: cultures and stocks of microorganisms and biologicals; blood and blood products; pathological wastes; radiological contrast agents, syringe needles; animal carcasses, body parts, bedding and related wastes; isolation wastes; any residue resulting from a spill cleanup; and any waste mixed with or contaminated by infectious medical waste. Facilities which generate infectious medical waste include: hospitals, doctors offices, dentists, clinics, laboratories, research facilities, veterinarians, ambulance squads, and emergency medical service providers, etc. Infectious medical waste is even generated in homes by home health care providers and individuals, such as diabetics, who receive injections at home.

Before infectious medical waste can be disposed of the waste must be sterilized. Traditional sterilization methods include: incineration; steam treatment or autoclaving; and liquid waste may be disposed of in approved sanitary sewers. More recent methods that have been developed include microwave irradiation and use of various chemical washes.

Transforming waste from a liability to an asset is a high global priority. Currently employed technologies that rely on incineration to dispose of carbonaceous waste with useable quantities of heat being generated while requiring scrubbers and other pollution controls to limit gaseous and particulate pollutants from entering the environment. Incomplete combustion associated with conventional incinerators and the complexities of operation in compliance with regulatory requirements often mean that waste which would otherwise have value through processing is instead sent to a landfill or incinerated off-site at considerable expense. As medical waste often contains appreciable quantities of synthetic polymers including polyvinyl chloride (PVC), incineration of medical waste is often accompanied by release of chlorine, ClOₓ, SOₓ, and NOₓ air pollutants that must be scrubbed from the emitted gases. Alternatives to incineration have met with limited success owing to complexity of design and operation outweighing the value of the byproducts from waste streams. Thus, the existing methods of disposing of infectious waste do not create energy or usable byproducts to justify replacement of traditional disposal methods

While there have been many advances in the treatment and disposal of infectious waste, there still exists a need for systems and methods for the safe treatment of infectious waste that maximize the economic return from the treated waste while also protecting the environment.

### SUMMARY OF THE INVENTION

A system for treating infectious waste includes a sealed enclosure that houses a shredder that is fed by a belt conveyor that supplies the infectious waste running from the exterior of the sealed enclosure to the shredder. The shredder further includes a hopper to receive waste and a process airlock where shredded wasted material accumulates and is transferred to the feed conveyor. A rubberized exterior flap permits containerized and bagged waste to enter the sealed enclosure via the belt conveyor. The sealed enclosure may be maintained at a negative pressure. A thermal oxidizer in fluid communication with the sealed enclosure and a hood acts to destroy any airborne infectious matter from the sealed enclosure and any airborne infectious waste collected by the hood. The thermal oxidizer may be run on a mixture of natural gas and reaction-produced carbonization process gases re-circulated to transform heat through the use of either conventional steam boilers or through Organic Rankin Cycle strategies to operate electrical turbine generators, or in the alternative, to conventional or novel reciprocating engine driven generators. A feed conveyor transfers shredded material from the shredder to a carbonizer.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of an infectious waste treatment system according to an embodiment of the invention;

FIG. 2 is a side section view depicting an encapsulated shredding and infectious matter escape prevention sub-system according to an embodiment of the invention;

FIG. 3 is an oxidizer adapted for use with embodiments of the invention; and

FIG. 4 is a block diagram of a top loaded infectious waste treatment system according to an embodiment of the invention.

### DESCRIPTION OF THE INVENTION

The present invention has utility as a system for treating infectious waste. Through inclusion of a medical waste handling and shredding sub-system feeding partially processed waste to an oxidizer to eliminate potential airborne infectious waste prior to transforming the medical waste into useful co-products the aforementioned limitations of the prior art have been overcome. According to the present invention, medical waste is transformed into value added products including hydrocarbon based gases, hydrocarbon-based liquids, carbonized material, and recovered precious metals and rare earth materials in a system having as its transformative element an anerobic, negative pressure, or carbonization system. With medical waste as a feedstock for the production of valuable products, the present invention provides an economically viable and environmentally more responsible alternative to traditional methods of medical waste treatment.

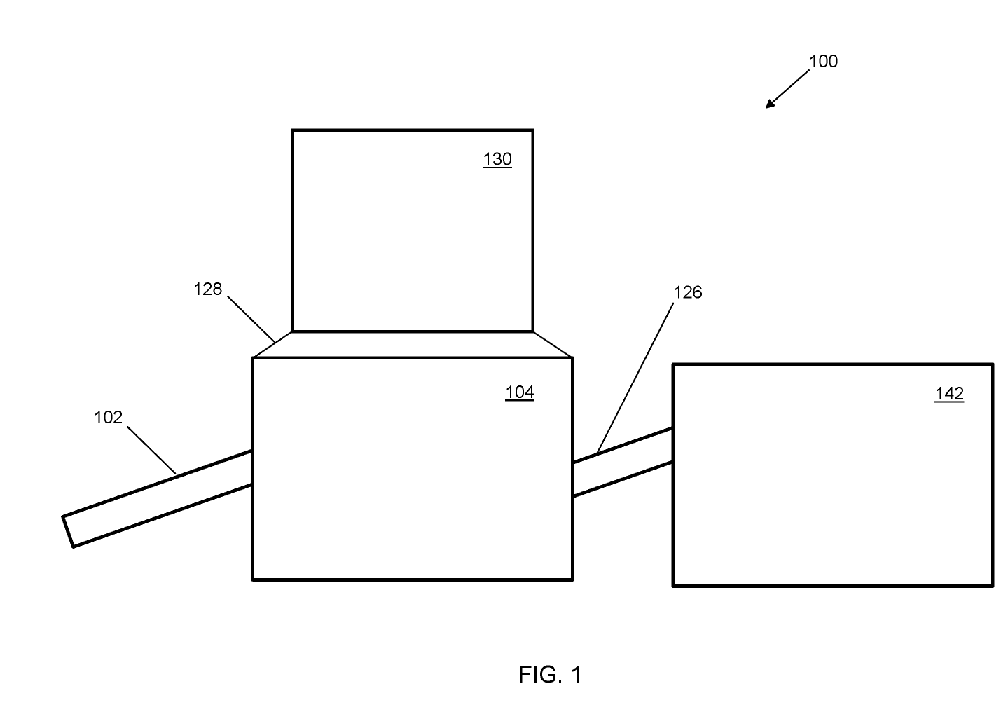

Referring now to the figures, embodiments of an inventive infectious waste system are described. FIG. 1 is a block diagram of an infectious waste treatment system 100 according to an embodiment of the invention. An encapsulated shredding and infectious matter escape prevention sub-system 104 encloses a shredder in a negative pressure sealed environment that acts to contain residue and contaminants from escaping into the environment during the shredding operation. The infectious waste is loaded into the sub-system 104 via belt conveyor 102. The belt conveyor 102 introduces the infectious or contaminated waste in bags or containers into the subsystem 104. An oxidizer 130 destroys any airborne infectious matter that exits through hood 128 at the top of the sub-system 104.

As used herein an oxidizer is defined to also include a thermal oxidizer and catalytic oxidizer; such systems are commercially available and in widespread usage.

Feed conveyor 126 transfers the shredded material from the sub-system 104 to the carbonizer 142. It is appreciated that feed conveyor 126 also includes augers, shuttle bins, and other conventional devices to transit shredded material.

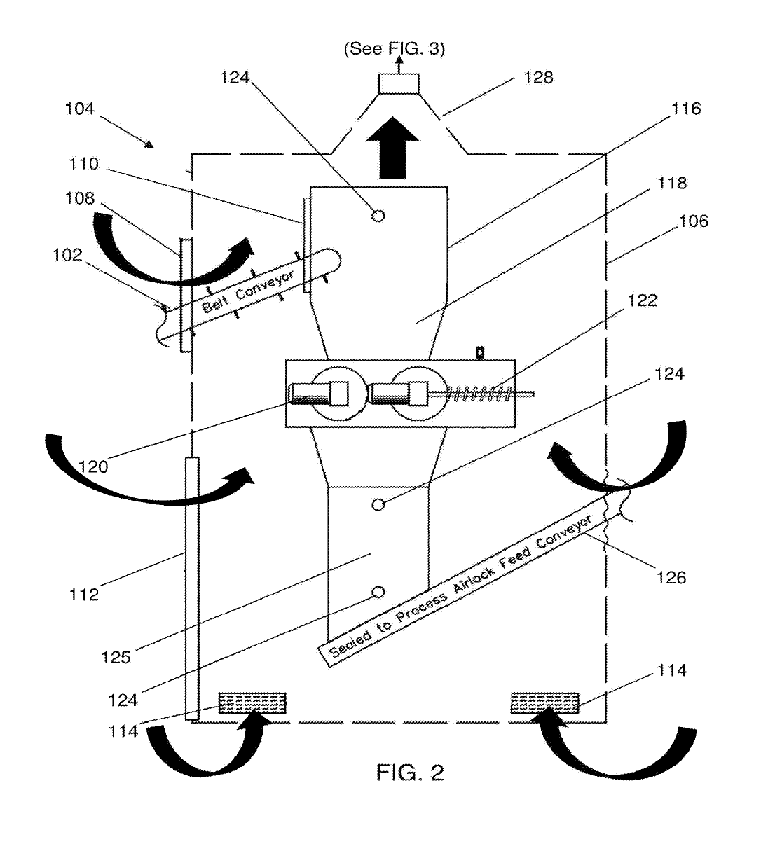

FIG. 2 is a side section view depicting the encapsulated shredding and infectious matter escape prevention sub-system 104. The dotted lines represent the containment walls 106 that enclose the shredder 116. The enclosure of the sub-system 104 is maintained at a negative pressure to draw in air (as opposed to expelling air) as represented by the arrows into the vents 114, as well as into the exterior flap 108 that permits containerized waste to enter the sub-system 104 via the belt conveyor 102, and other openings such as for the feed conveyor 126 and service door 112. The exterior flap 108 is readily formed of rubberized materials, polymeric sheeting, as well as metals. Service door 112 is provided in some inventive embodiments to allow service workers to enter the enclosure. It is appreciated that a service person may be required to wear protective clothing and a filter mask. In a specific embodiment the service door 112 may be a double door airlock, where only one door is open at a time to minimize the escape of contaminants into the environment. In still other embodiments, the air handling system modifies operation during opening of the service door 112 to maintain a negative pressure during opening to inhibit airborne escape of potential pathogens. Hopper flap 110 acts to allow containerized waste to enter the hopper 118 of the shredder 116, while also acting as a seal around the belt conveyor 102. The hopper flap 110 is readily formed of rubberized materials, polymeric sheeting, as well as metals. At the bottom of the hopper 118, an auger 122 that is driven by one or more motors 120 shreds the waste. In an embodiment the motors 120 may be variable frequency drive (VFD) motors. The shredded material is accumulated in a process airlock 125 that supplies material to a feed conveyor 126. Levels and presence of material within the hopper 118 and the process airlock 125 are controlled via sensors 124. In a specific embodiment the sensors 124 are through beam sensors (TBS). Feed conveyor 126 is sealed to the process airlock 125, and transports the shredded material from the sub-system 104 to the carbonizer 142. Hood 128 collects airborne contaminants for introduction into the oxidizer (TO) 130.

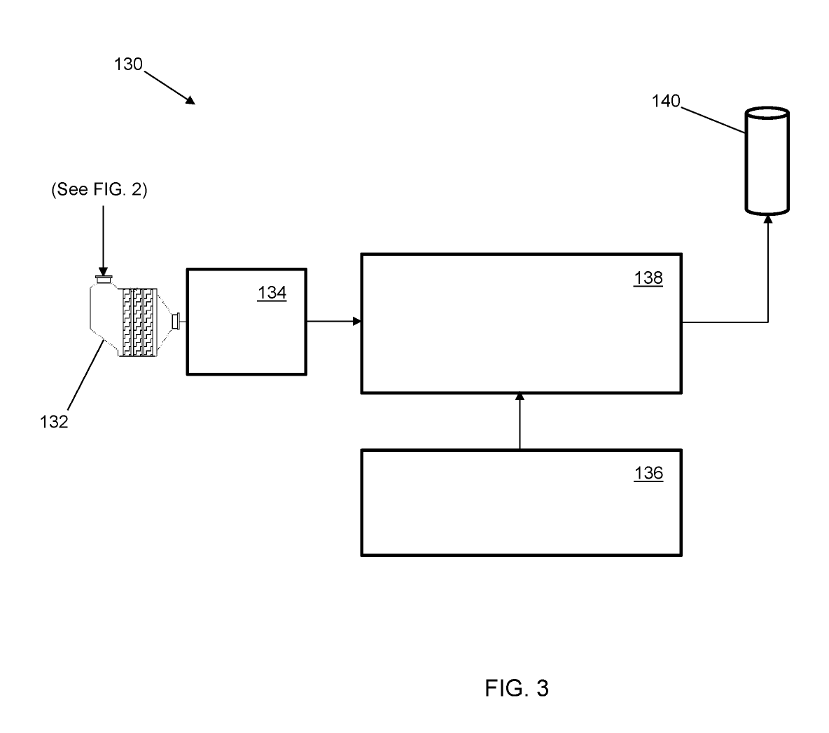

FIG. 3 is a block diagram of an oxidizer 130 adapted for use with embodiments of the invention that acts as a fume incinerator for the containment room of sub-system 104. Large particle screener 132 filters out particles from the exhaust stream of airborne contaminants. A filter differential sensor may be employed to detect when a filter is clogged and requires replacement. A blower 134 draws in the exhaust stream and blows the exhaust stream into the combustion tube 138. A gas supply 136 supplies fuel for burners in the combustion tube 138. In specific embodiments the oxidizer 130 is run on a mixture of natural gas and reaction-produced carbonization process gases re-circulated to transform the heat through the use of either conventional steam boilers or to Organic Rankin Cycle strategies to operate electrical turbine generators, or in the alternative, to reciprocating engine driven generators, and thereby generate the heat needed to produce power while also operating the carbonization process in the carbonizer 142. This heat capture produces more waste heat than is used to heat water and generate steam for turbines or steam reciprocating engines. This heat in some inventive embodiments is used to preheat feedstock or for other larger process purposes. The pre-processing heating system preheats feedstock material prior to entering the reactor tube to both reduce moisture and improve overall system yield. Roof exhaust stack 140 vents cleaned exhaust to the environment.

An apparatus for anaerobic thermal transformation processing as carbonizer 142 to convert waste into bio-gas; bio-oil; carbonized materials; non-organic ash is detailed in U.S. Pat. No. 8,801,904; the contents of which are incorporated herein by reference.

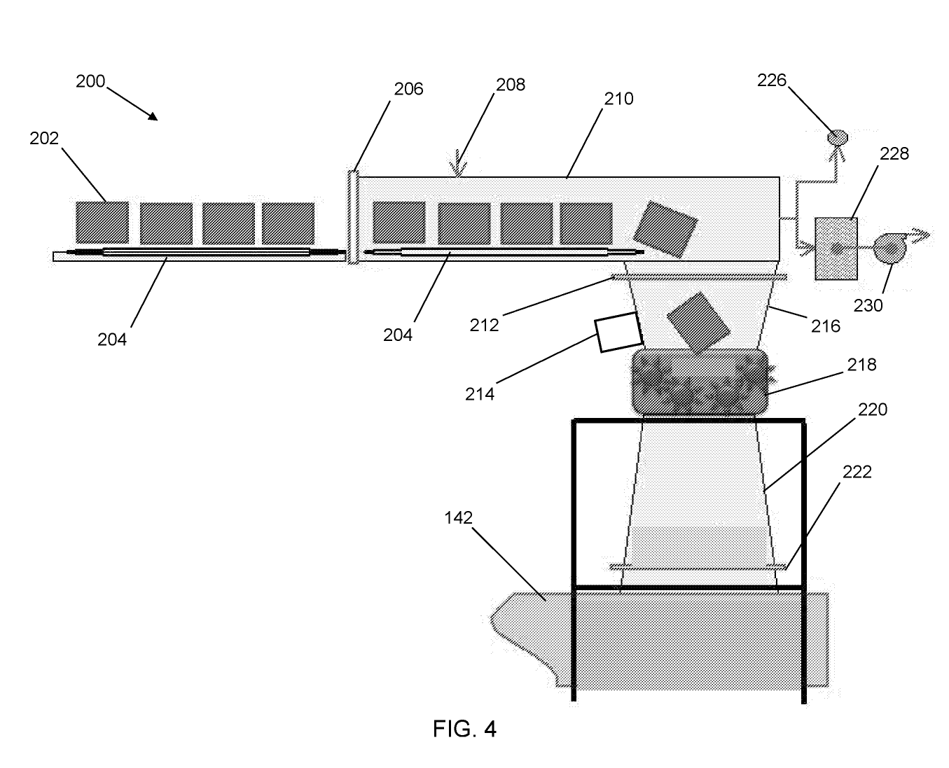

FIG. 4 illustrates a block diagram of a shredder feed system 200 for treatment and recovery of usable products from waste feedstock illustratively including medical and infectious waste, where the carbonizer 142 is that described with respect to the aforementioned drawings. The feed system 200 utilizes conveyers 204 to feed and transport containers 202 of waste into and through the pre-shred air-lock tunnel 210 and into a shred feed hopper 216. The pre-shred air-lock tunnel 210 has an airtight open and close inlet valve (door) 206 and an outlet valve (door) 212 to the shred feed hopper 216. The pre-shred air-lock tunnel 210 may have nitrogen inputted at valve 208 to provide an inert atmosphere in the air-lock tunnel 210. In a specific embodiment the waste may be treated with a wet scrubber 214. Medical waste that contains appreciable quantities of synthetic polymers including polyvinyl chloride (PVC), when incinerated is often accompanied by release of chlorine, ClOₓ, SOₓ, and NOₓ air pollutants that are preferably scrubbed from the emitted gases to limit air pollution. The wet scrubber 214 facilitates a reaction with chloride gas to yield a resultant hydrochloric acid (HCl) product. In order to withstand corrosion caused by HCl, and other byproducts produced in operation of an inventive system, system components are readily formed of solid-solution-strengthened, high-temperature corrosion-resistant alloys that are generally rich in nickel and chromium/cobalt as major constituents with illustratively include 37Ni-29Co-28Cr-2Fe-2.75Si-0.5Mn-0.5Ti-0.05C-1W-1Mo-1Cb, S13Cr, 316L (S31603), 22 Cr duplex, 25 Cr duplex, 28 (N08028), 825 (N08825), 2550 (N06975), 625 (N06625) C-276 (N10276), where parentheticals correspond to the UNS numbers for a particular alloy. These alloys are resistant to the effects of HCl may be used in the construction of one or more of the wet scrubber 214, shred feed hopper 216, shredder 218, and other components of the system 200 that may contact the corrosive HCl and chlorine, such as the sealed enclosure, the shredder, the belt conveyor, the oxidizer, or the feed conveyor.

Continuing with FIG. 4, the shredder 218 may be a two or four shaft shredder that is mounted so that all shredded waste material and liquids exit the bottom of the shredder 218 into a collection hopper 220 that meters and distributes the waste with a post-shred air-lock 222 directly into a carbonizer 142. It is appreciated, precious metals and rare-earth materials for example associated with medical imaging may be obtained by burning off the carbon product to obtain carbon dioxide and the resultant metal materials. For example, contrast agents used for radiological procedures are a source of precious metals and rare earths. Gasses from the air-lock tunnel are managed with an oxygen sensor 226 and escaping particulate is filtered with a high-efficiency particulate air (HEPA) filter 228. and is the expelled through a blower 230 to an oxidizer illustratively including a thermal oxidizer.

As a person skilled in the art will recognize from the previous detailed description and from the figures and claims, modifications and changes can be made to the preferred embodiments of the invention without departing from the scope of this invention defined in the following claims.

1. A system for treating infectious waste, the system comprising:
a sealed enclosure;
a shredder within said sealed enclosure;
a belt conveyor to supply the waste, said belt conveyor running from an exterior of said sealed enclosure to said shredder;
an oxidizer in fluid communication with said sealed enclosure adapted to destroy airborne infectious matter from said sealed enclosure; and
a feed conveyor for transfer of shredded material from said shredder to a carbonizer.

2. The system of claim 1 wherein the sealed enclosure is maintained at a negative pressure.

3. The system of claim 1 further comprising a rubberized exterior flap that permits containerized and bagged waste to enter the sealed enclosure via said belt conveyor.

4. The system of claim 1 wherein said sealed enclosure further comprises a hood that collects said airborne contaminants for introduction into said thermal oxidizer.

5. The system of claim 1 wherein said oxidizer further comprises a large particle screener.

6. The system of claim 1 wherein said oxidizer further comprises a blower for that draws in said airborne infectious matter into a combustion tube.

7. The system of claim 1 further comprising a roof exhaust stack to vent cleaned exhaust to the environment.

8. The system of claim 1 wherein said oxidizer is a thermal oxidizer.

9. The system of claim 1 wherein said oxidizer further comprises a gas supply that supplies fuel for burners in a combustion tube.

10. The system of claim 9 wherein said oxidizer is run on a mixture of natural gas and reaction-produced carbonization process gases re-circulated to transform heat through the use of a steam boiler, an organic Rankin Cycle, or a combination thereof.

11. The system of claim 1 wherein said shredder further comprises a hopper to receive waste and a process airlock where shredded wasted material accumulates and is transferred to said feed conveyor.

12. The system of claim 11 wherein levels and presence of accumulated waste and shredded waste is controlled via one or more sensors.

13. The system of claim 12 wherein said one or more sensors are through beam sensors.

14. The system of claim 1 further comprising a wet scrubber in fluid communication with said sealed enclosure.

15. The system of claim 1 wherein one or more of said sealed enclosure, said shredder, said belt conveyor, said oxidizer, or said feed conveyor is formed of a corrosion resistant alloy composed predominantly of a combination of nickel with chromium, cobalt, or a combination thereof.

16. A process of carbonizing medical waste comprising the operation of the system of claim 1.
